(19) United States
(12) Patent Application Publication
(10) Pub. No.: US 2008/0298276 A1
(43) Pub. Date: Dec. 4, 2008

(54) Analytical Framework for Multinode Storage Reliability Analysis

(75) Inventors: Ming Chen, Beijing (CN); Wei Chen, Beijing (CN); Zheng Zhang, Beijing (CN)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/756,183

(22) Filed: May 31, 2007

(51) Int. Cl. G08C 15/00; G06F 12/00

(52) U.S. Cl. 370/255; 370/216; 707/200

(57) ABSTRACT

A analytical framework is described for quantitatively analyzing reliability of a multinode storage system, such as a brick storage system. The framework defines a multidimensional state space of the multinode storage system and uses a stochastic process (such as Markov process) to determine a transition time-based metric measuring the reliability of the multinode storage system. The analytical framework is highly scalable and may be used for quantitatively predicting or comparing the reliability of storage systems under various configurations without requiring experimentation and large-scale simulations.

### BACKGROUND

The reliability of multinode storage systems using clustered data storage nodes has been a subject matter of both academic interests and practical significance. Among various multinode storage systems, brick storage solutions using “smart bricks” connected with a network such as Local Area Network (LAN) face a particular reliability challenge. One reason for this is because inexpensive commodity disks used in brick storage systems are typically more prone to permanent failures. Additionally, disk failures are far more frequent in large systems.

A “smart brick” or simply “brick” is essentially a stripped down computing device such as a personal computer (PC) with a processor, memory, network card, and a large disk for data storage. The smart-brick solution is cost-effective and can be scaled up to thousands of bricks. Large scale brick storage fits the requirement for storing reference data (data that are rarely changed but need to be stored for a long period of time) particularly well. As more and more information being digitized, the storage demand for documents, images, audios, videos and other reference data will soon become the dominant storage requirement for enterprises and large internet services, making brick storage systems an increasingly attractive alternative to generally more expensive Storage Area Network (SAN) solutions.

To guard against permanent loss of data, replication is often employed. The theory is that if one or more, but not all, replicas are lost due to disk failures, the remaining replicas will still be available for use to regenerate new replicas and maintain the same level of reliability. New bricks may also be added to replace failed bricks and data may be migrated from old bricks to new bricks to keep global balance among bricks. The process of regenerating lost replicas after brick failures is referred to as data repair, and the process of migrating data to the new replacement bricks is referred to as data rebalance. These two processes are the primary maintenance operations involved in a multinode storage system such as a brick storage system.

The reliability of brick storage system is influenced by many parameters and policies embedded in the above two processes. What complicates the analysis is the fact that those factors can have mutual dependencies. For instance, cheaper disks (e.g. SATA vs. SCSI) are less reliable but they give more headroom of using more replicas. Larger replication degree in turn demands more switch bandwidth. Yet, a carefully designed replication strategy could avoid the burst traffic by proactively creating replicas in the background. Efficient bandwidth utilization depends on both the given (i.e. switch hierarchy) and the design (i.e. placement strategy). Object size also turns out to be a non-trivial parameter. Moreover, faster failure detection and faster replacement of failed bricks can provide better data reliability, but they incur increased system cost and operation cost.

While it is easy to see how all these factors qualitatively impact the data reliability, it is important for system designers and administrators to understand the quantitative impact, so that they are able to adjust the system parameters and design strategies to balance the tradeoffs between cost, performance, and reliability. Although the knowledge of system reliability may be acquired through information gathering, experimentation, and simulation, these approaches are not always practical, especially for large storage systems.

### SUMMARY

An analytical framework is described for analyzing reliability of a multinode storage system, such as a brick storage system using stripped-down PC having disk(s) for storage. The analytical framework is able to quantitatively analyze (e.g., predict) the reliability of a multinode storage system without requiring experimentation and simulation.

The analytical framework defines a state space of the multinode storage system using at least two coordinates, one a quantitative indication of online status of the multinode storage system, and the other a quantitative indication of replica availability of an observed object. The framework uses a stochastic process (such as Markov process) to determine a metric, such as the mean time to data loss of the storage system (MTTDL_{sys}), which can be used as a measure of the reliability of the multinode storage system.

The analytical framework may be used for determining the reliability of various configurations of the multinode storage system. Each configuration is defined by a set of parameters and policies, which are provided as input to the analytical framework. The results may be used for optimizing the configuration of the storage system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The detailed description is described with reference to the accompanying figures. In the figures, the left-most digit(s) of a reference number identifies the figure in which the reference number first appears. The use of the same reference numbers in different figures indicates similar or identical items.

FIG. 1 shows an exemplary multinode storage system to which the present analytical framework may be used for reliability analysis.

FIG. 2 is a block diagram illustrating an exemplary process for determining reliability of a multinode storage system.

FIG. 3 shows an exemplary process for determining MTTDL_{sys}, the mean time to data loss of the system.

FIG. 4 shows an exemplary discrete-state continuous-time Markov process used for modeling the dynamics of replica maintenance process of the brick storage system of FIG. 1.

FIG. 5 shows an exemplary state space transition pattern based on the Markov process of FIG. 4.

FIG. 6 shows an exemplary process for approximately determining the number of independent objects reply.

FIG. 7 shows an exemplary environment for implementing the analytical framework to analyze the reliability of the multinode storage system.

FIG. 8 shows sample results of applying the analytical framework to predict the reliability of the brick storage system with respect to the size of the objects in the system.

FIG. 9 shows sample results of applying the analytical framework to compare the reliability achieved by reactive pair and the reliability achieved by mixed repair with varied bandwidth budget allocated for proactive replication.

FIG. 10 shows an exemplary transition pattern of an extended model that covers detection delay.

FIG. 11 shows sample reliability results of the extended model of FIG. 10.

FIG. 12 shows an exemplary transition pattern of an extended model that covers failure replacement delay.

FIG. 13 shows sample computation results of impact on MTTDL by replacement delay.

### DETAILED DESCRIPTION

In this description, a brick storage system in which each node has a smart brick is used for the purpose of illustration. It is appreciated, however, the analytical framework may be used to any multinode storage system which may be approximately described by a stochastic process. A stochastic process is a random process characterized by a future evolution described by probability distributions instead of being determined with a single “reality” of how the process might evolve under time. (as in a deterministic process or system). This means that even if the initial condition (or a starting state) is known, there are multiple possibilities (paths) the process might go to, although some paths are more probable than others. One of the most commonly used models to analyze a stochastic process is Markov chain model or Markov process. In this description, Markov process is used for the purpose of illustration. It is appreciated that other suitable series for models may be used.

Although the analytical framework is applied to several sample brick storage systems and its results used for predicting several trends and design preferences, the analytical framework is not limited to such exemplary applications, and is not predicated on the accuracy of the results or predictions that come from the exemplary applications.

Furthermore, although the analytical framework is demonstrated using exemplary processes described herein, it is appreciated that the orders in which processes described herein are not intended to be construed as a limitation, and any number of the described process blocks may be combined in any order to implement the method, or an alternate process

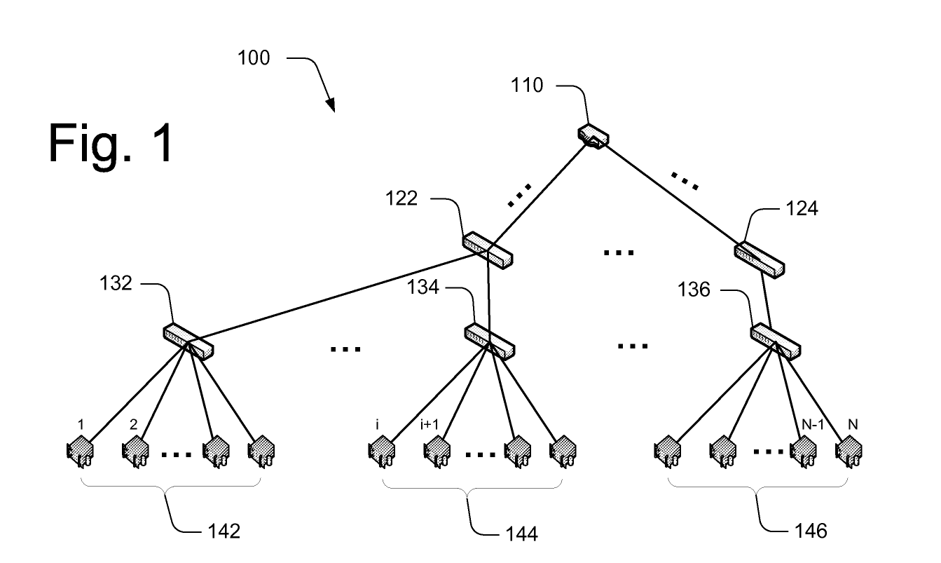

FIG. 1 shows an exemplary multinode storage system to which the present analytical framework may be used for reliability analysis. The brick storage system 100 has a tree topology including a root switch (or router) 110, leaf switches (or routers) at different levels, such as leaf switches 122, 124 and omitted ones therebetween at one level, and leaf switches 132, 134, 136 and omitted ones therebetween at another level. The brick storage system 100 uses N bricks (1, 2, . . . i, i+1, . . . , N−1 and N) grouped into clusters 102, 104, 106 and omitted ones therebetween. The bricks in each cluster 102, 104 and 106 are connected to a corresponding leaf switch (132, 134 and 136, respectively). Each brick may be a stripped-down PC having CPU, memory, network card and one or more disks for storage, or a specially made box containing similar components. If a PC has multiple disks, the PC may be treated either as a single brick or multiple bricks, depending on how the multiple disks are treated by the data object placement policy, and whether the multiple disks may be seen as different units having independent failure probabilities.

Multiple data objects are stored in the brick storage system 100. Each object has a desired number of replicas stored in different bricks.

In order to analytically and quantitatively analyze the reliability of the brick storage system, the framework defines a state space of the brick storage system. Each state is described by at least two coordinates, of which one is a quantitative indication of online status of the brick storage system, and the other a quantitative indication of replica availability of an observed object.

For instance, the state space may be defined as (n, k), where n denoting the current number of online bricks, and k denoting the current number of replicas of the observed object. The framework uses a stochastic process (such as Markov process) to determine a metric measuring a transition time from a start state to an end state. The metric is used for estimating the reliability of the multinode storage system. An exemplary metric for such purpose, as illustrated below, is the mean time to data loss of the system, denoted as MTTDL_{sys}. After the system is loaded with desired number of replicas of the objects, MTTDL_{sys} is mean expected time when the first data object is lost by the system, and is thus indicative of the reliability of the storage system.

Based on the state space, a state space transition pattern is defined and corresponding transition rates are determined. The transition rates are then used by the Markov process to determine the mean time to data loss of the storage system (MTTDL_{sys}).

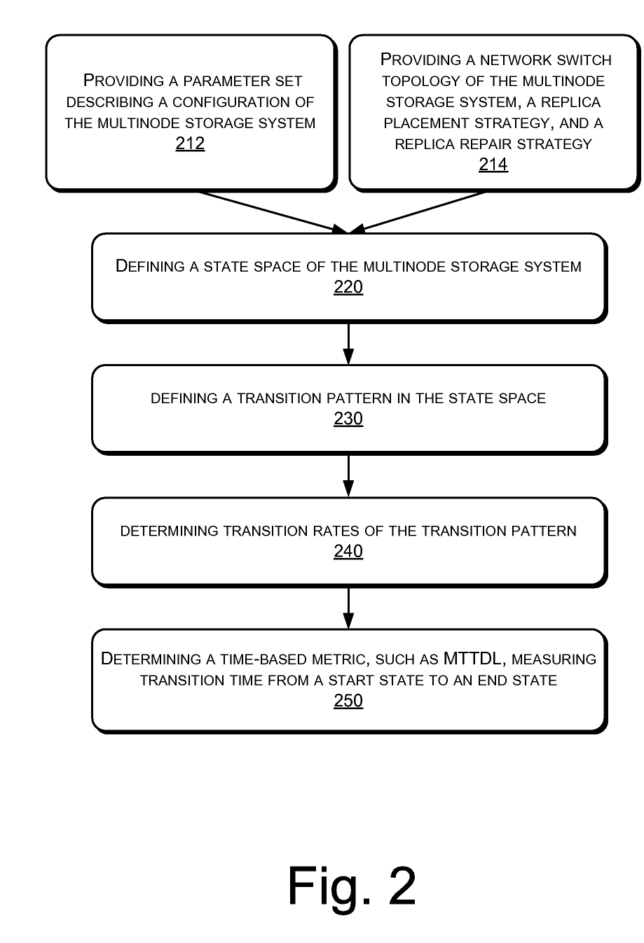

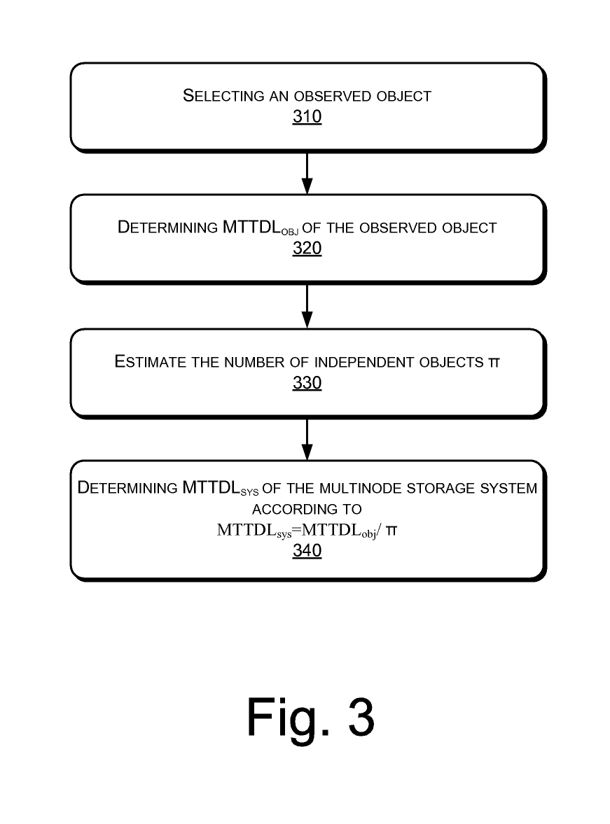

FIG. 2 is a block diagram illustrating an exemplary process for determining reliability of a multinode storage system. The process is further illustrated in FIGS. 3-5. Blocks 212 and 214 represent an input stage, in which the process provides a set of parameters describing a configuration of the multinode storage system (e.g., 100), and other input information such as network switch topology, replica placement strategy and replica repair strategy. The parameters describing the configuration of the system may include, without limitation, number of total nodes (N), failure rate of a node (λ), desired number of replicas per object (replication degree K), total amount of unique user data (D), object size (s), switch bandwidth for replica maintenance (B), node I/O bandwidth, fraction of B and b allocated for repair (p), fraction of B and b allocated for rebalance (q, which is usually 1−p), failure detection delay, and brick replacement delay.

It is appreciated that some of the above input information is optional and may selectively provided according to the purpose of the analysis. In addition, some or all of the parameters and input information may be provided at a later stage, for example after block 240 and before block 250.

At block 220, the process defines a state space of the multinode storage system. In one embodiment, the state space is defined by (n, k) where n is the number of online nodes (bricks) and k is number of existing replicas.

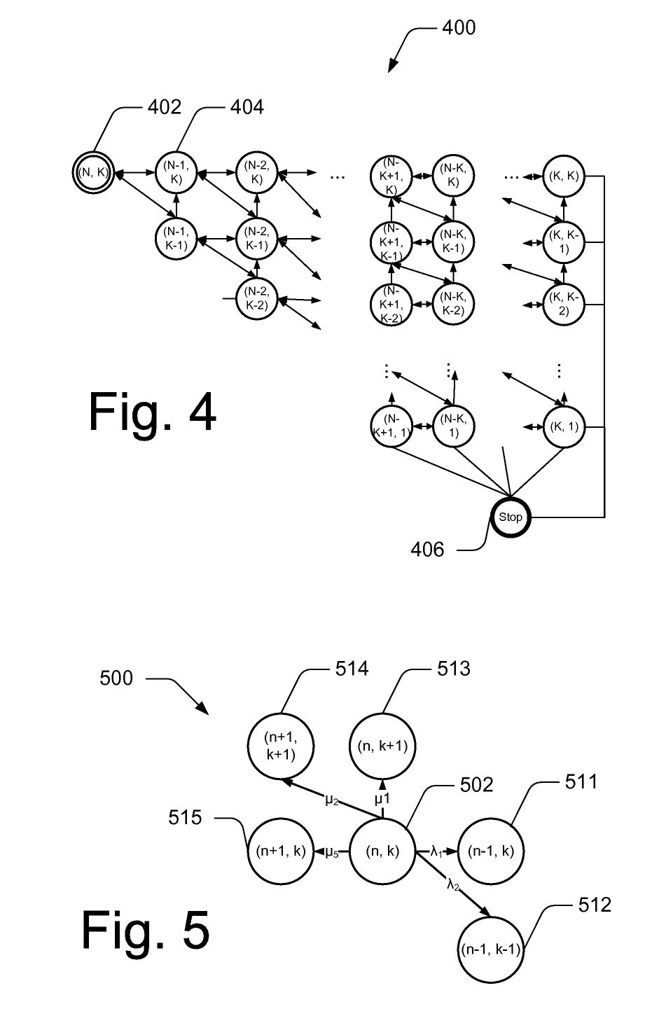

At block 230, the process defines a state space transition pattern in the state space. An example of state space transition pattern is illustrated in FIGS. 4-5.

At block 240, the process determines transition rates of the state space transition pattern, as illustrated in FIG. 5 and the associated text.

At block 250, the process determines a time-based metric, such as MTTDL_{sys}, measuring transition time from a start state to an end state. If the start state is an initial state (N, K) and the stop state is an absorbing state (n, 0), the metric MTTDL_{sys} would indicate the reliability of multinode storage system. In initial state (N, K), N is the total number of nodes, and K the desired replication degree (i.e., the desired number of replicas for an observed object). In the absorbing state (n, 0), n is the number of remaining nodes online and “0” indicates that all replicas of the observed object have been lost and the observed object is considered to be lost.

FIG. 3 shows an exemplary process for determining MTTDL_{sys}, In this exemplary process, MTTDL_{sys} is determined in two major steps. The first step is to choose an arbitrary object (at block 310), and analyze the mean time to data loss of this particular object, denoted as MTTDL_{obj} (at block 320). The second step is to estimate the number of independent objects denoted as π (at block 330), and then determine the mean time to data loss of the system is given as (at block 340):

MTTDL_{sys}=MTTDL_{obj}/π.

The number of independent objects 71 is the number of objects which are independent in terms of data loss behavior. Exemplary methods for determining MTTDL_{obj} and π are described below.

### Markov Model for Determining MTTDL_{obj}

FIG. 4 shows an exemplary discrete-state continuous-time Markov process used for modeling the dynamics of replica maintenance process of the brick storage system of FIG. 1.

The Markov process 400 is represented by a discrete-state map showing multiple states, such as states 402, 404 and 406, each indicated by a circle. A state in the Markov process 400 is defined by two coordinates (n, k), where n is the number of online bricks, and k is the current number of replicas of the observed object still available among the online bricks. Each state (n, k) represents a point in a two dimensional state space.

As will be shown, at each state, data repair for the particular object is affected by the available system bandwidth and the amount of data to be repaired. These quantities are determined by the total number of bricks that remain online in the system. Coordinate n in the definition of the state provides for such determinations. A brick is online if it is functional and is connected to the storage system. In some embodiments, a brick may be considered online only after it has achieved the balanced load (e.g., stores an average amount of data).

Coordinate k in the definition of the state is used to denote how many copies of the particular object are still remaining and when system arrives at an absorbing state in which the observed object is lost. Explicit use of replica number k in the state is also useful when extending the model to consider other replication strategies, such as proactive replication as discussed later.

Initially the system is in state (N, K) 402, where N is the total number of bricks and K is the replication degree, i.e., the desired number of replicas for the observed object. The model has an absorbing state 406, stop, which is the state when all replicas of the object are lost before any repair is successful. The absorbing state is described by (n, 0). Data loss occurs when the system transitions into the stop state 406. MTTDL_{obj} is computed as the mean time from the initial state 402 (N, K) to the stop state 406 (n, 0).

In the embodiment shown, the total number n of online disks has a range of K≦n≦N, meaning that states in which the number of online disks is smaller than the number of desired replicas K are not considered. This is because in such states there are not enough online disks to store each of the desired K replicas on a separate disk. Duplicated replicas on the same disc do not have independent contribution to reliability as all duplicate replicas are lost at the same time when the disk fails.

In this embodiment, the current number k of replicas of the observed object has a range of 0≦k≦K, meaning that once the number of replicas of the observed object reaches the desired duplication degree K, no more replicas of the observed object is generated. However, in some embodiments using proactive replication, k may have a range of 0≦k≦K+Kₚ, where Kₚ denotes maximum number of additional replicas of the observed object generated by proactive replication.

Using the state space, the framework defines a state space transition pattern between the states in the state space, and determines transition rates of the transition pattern. The determined transition rates are used for determining MTTDL_{obj}.

FIG. 5 shows an exemplary transition pattern based on the Markov process of FIG. 4. The state space transition pattern 500 includes the following five transitions from state (n, k) 502:

a first transition from state (n, k) 502 to state (n−1, k) 511 in which a brick fails but does not lose a replica of the observed object occurs;

a second transition from state (n, k) 502 to state (n−1, k−1) 512 in which the brick fails and a replica of the observed object is lost;

a third transition from state (n, k) 502 to state (n, k+1) 513 in which a repair replica of the observed object is generated among the remaining n bricks;

a fourth transition from state (n, k) 502 to state (n+1, k+1) 514 in which a new brick is added for data rebalancing and a repair replica of the observed object is generated in the new brick; and

a fifth transition from state (n, k) 502 to state (n+1, k) 515 in which a new brick is added for data rebalancing without generating a repair replica of the observed object.

The above five transitions each has a transition rate, denoted by λ₁, λ₂, μ₁, μ₂ and μ₃, respectively, which are determined as follows. Assume that each individual brick has an independent failure rate of λ. The first transition rate λ₁ is the rate of the transition moving to (n−1,k), a case where a brick fails but does not contain a replica. Since there are k bricks that do contain a replica, and correspondingly there are (n−k) bricks that do not contain a replica, the first transition rate λ₁ is given by λ₁=(n−k)λ.

The second transition rate λ₂ is the rate of the transition moving to (n−1,k−1), in which case the failed brick contains a replica. Since there are k bricks that contain a replica, the second transition rate λ₂ is given by λ₂=kλ.

Transition rates μ₁, μ₂, and μ₃ are the rates for repair and rebalance transitions. When the system is in state (n, k), data repair is performed to regenerate all lost replicas that were stored in the failed N−n bricks. Regenerated replicas are stored among the remaining n bricks. Data repair can be used to regenerate lost replicas at the fastest possible speed. This is because in a data repair all n remaining bricks may be allowed to participate in the repair process, and the data repair can thus be done in parallel and can be very fast.

In comparison, data rebalance is carried out to regenerate all lost replicas on the new bricks that are installed to replace the failed bricks. For example, assume the number of online bricks is brought up to the original total number N by adding N−n new bricks, in data rebalance a new brick is filled with the average amount of data and then brought online for service. The same is done on all N−n new bricks. The purpose of data rebalance is to achieve load balance among all bricks and bring the system back to a normal state.

In some configurations, data repair and data rebalance are conducted at the same time. This can be important because data rebalance may be taking its time while fast data repair helps to prevent the brick storage system from transitioning to an absorbing state where all replicas are lost before data rebalance is completed. When both data repair and data rebalance are complete, some replicas regenerated on existing bricks may be redundant and may be deleted to keep the desired replication degree K.

Transition rates μ₁, μ₂, and μ₃ depend on several factors such as the configuration of brick storage system. These factors may be described by a set of parameters including number of total nodes (N), failure rate of a node (λ), desired number of replicas per object (replication degree K), total amount of unique user data (D), object size (s), switch bandwidth for replica maintenance (B), node I/O bandwidth, fraction of B and b allocated for repair (p), fraction of B and b allocated for rebalance (q, which is usually 1−p), failure detection delay, brick replacement delay and bandwidth of the system.

In an exemplary basic model illustrated below, it is assumed that brick failures are detected instantaneously and new bricks installed immediately to replace failed bricks. However, other more sophisticated models may be used to take into consideration failure detection delays and brick replacement delays, as will be shown in later parts of this description.

Transition rate μ₁ is the rate of data repair from state (n, k) to (n, k+1). In state (n, k), the data repair process regenerates (K−k) replicas among the remaining n bricks in parallel. Let i=1, 2, . . . K−k denote the (K−k) bricks receiving these replicas, coefficients d_{r,i} and b_{r,i} are defined as follows for determining the transition rate μ1:

d_{r,i} is the amount of data each brick i receives for data repair; and

b_{r,i} is the bandwidth brick i is allocated for repair.

Then b_{r,i}/d_{r,i} is the rate brick i completes the repair of a replica. Since all (K−k) replica repairs are in parallel, the overall repair rate:

μ₁=Σᵢ₌₁^{k-k}b_{r,i}/d_{r,i}

Transition rates μ₂ and μ₃ are for rebalance transitions filling the N−n new disks. In particular, μ₂ is the rate of completing the rebalance of the first new brick that contains a new replica (i.e., transitioning to state (n+1, k+1)), while μ₃ is the rate of completing the rebalance of the first new brick not containing a replica (i.e., transitioning to state (n+1, k)). Coefficients d₁ and b₁ are defined as follows and used for determining the transition rate μ₂ and μ₃:

d₁ it is the amount of data to be loaded to each of the N−n new bricks; and

b₁ is the available bandwidth (which is determined by backbone bandwidth, source brick aggregation bandwidth, and destination brick aggregation bandwidth) for copying data.

Thus the rate for each new brick to complete rebalance is b₁/d₁. Since (K-k) new bricks contain replicas of the object and (N−n)−(K−k) bricks do not, one has:

μ₂=(K−k)×b₁/d₁, and

μ₃=((N−n)−(K−k))×b₁/d₁.

The values of d_{r,i}, b_{r,i}, d₁, b₁, depend on placement and repair strategies and dare determined next for exemplary strategies such as random placement and repair strategy.

When all transition rates are known, MTTDL_{obj} can be computed with the following exemplary procedure.

Number all the states excluding the stop state to be state 1, 2, 3, . . . , with state 1 being the initial state (N, K). Let Q*=(q_{i,j}) be the transition matrix, where q_{i,j} is the transition rate from state i to state j. Then calculate matrix M=(I−Q*)⁻¹, from which MTTDL_{obj} is determined by:

MTTDL_{obj}=Σᵢm_{1,i},

where m_{1,i} is the element of M at the first row and the i-th column in the transition matrix. MTTDL_{sys} is then determined according to MTTDL_{sys}=MTTDL_{obj}/π.

### Estimating π, the Number of Independent Objects

One aspect of the present analytical framework is estimating the number of independent objects π. Each object has a corresponding replica set, which is a set of bricks that store the replicas of the object. The replica set of an object changes over time as brick failures, data repair and data rebalance keep occurring in this system. If the replica sets of two objects never overlap with each other, then the two objects are considered independent in terms of data loss behaviors. If the replica sets of two objects are always the same, then these two objects are perfectly correlated and they can be considered as one object in terms of data loss behavior. However, in most cases, the replica sets of two objects may overlap from time to time, in which cases the two objects are partially correlated, making the estimation of the number of independent objects difficult.

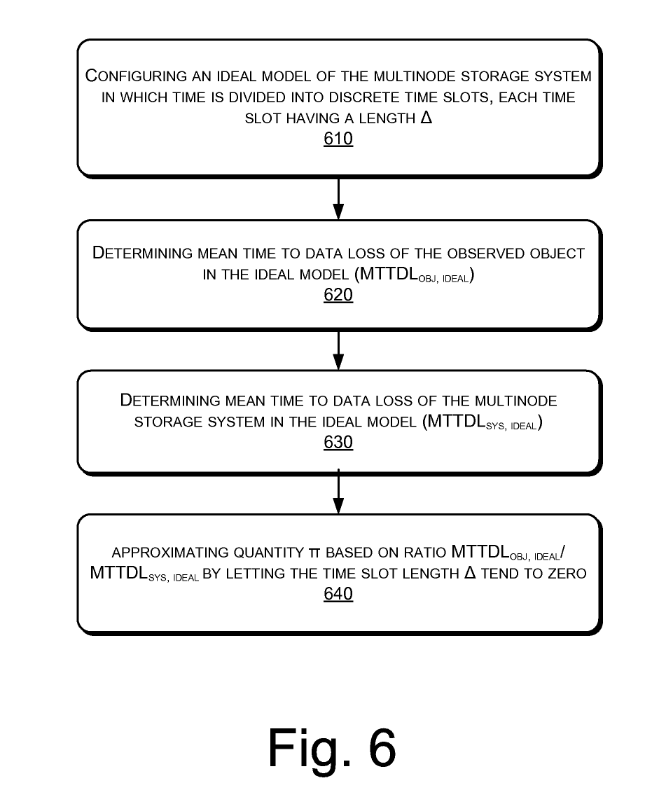

FIG. 6 shows an exemplary process for approximately determining the number of independent objects reply. The exemplary process considers an ideal model in which one can calculate the quantity π, and uses the calculated π of the ideal model as an estimate for π in the actual Markov model.

At block 610, the process configures an ideal model of the multinode storage system in which time is divided into discrete time slots, each time slot having a length Δ. Each time slot each node has an independent probability to fail, and at the end of each time slot, data repair and data rebalance are completed instantaneously;

At block 620, the process determines MTTDL_{obj, ideal} which is the mean time to data loss of the observed object in the ideal model.

At block 630, the process determines MTTDL_{sys, ideal}, which is the mean time to data loss of the multinode storage system in the ideal model.

At block 640, the process approximates π based on ratio MTTDL_{obj, ideal}/MTTDL_{sys, ideal} by letting the time slot length Δ tend to zero:

$${lim}_{P -> 0} \frac{{MTTDL}_{obj}}{{MTTDL}_{sys}} = π$$

In real systems data repair and rebalance can usually be done in a much smaller time scale (e.g., hours) comparing with the life time of a brick (e.g., years). Thus assuming instant data repair and rebalance in the ideal model would give a close estimate of π.

As will be shown below, in the ideal model, it is possible to derive the exact formulas for MTTDL_{obj} and MTTDL_{sys}. It is noted, however, that MTTDL_{obj, ideal} and MTTDL_{sys, ideal} may not need to be quantitatively determined at blocks 620 and 630, but instead only need to be expressed as a function of the time slot length Δ. In addition, MTTDL_{obj, ideal} and MTTDL_{sys, ideal} may not need to be separately determined in two separate steps. The method works as long as the ratio MTTDL_{obj, ideal}/MTTDL_{sys, ideal} can be expressed or estimated.

The following is an exemplary application of the above method for calculating (or estimating) π in a storage system where objects are randomly placed and randomly repaired among all bricks in the system. In the ideal model, time is divided into discrete slots, each of which with length Δ. Within each slot, each machine has an independent probability P to fail. At the end of each slot, data repair and data rebalance are completed instantaneously.

Given an object, the probability that the object is lost in one time slot is Pₒ which can be obtained as Pₒ=p^{K}, where K is the desired replication degree. The number of time slots it takes for the object to be lost follows a geometric distribution with probability Pₒ, and therefore

(1−Pₒ)Δ/Pₒ≦MTTDL_{obj}≦Δ/Pₒ.

If the total number of objects in the system is F, the probability that the system loses at least one object in one time slot is Pₛ, which is given by

$${P}_{s} = {\sum }_{i = K}^{N} {C}_{N}^{i} {{P}^{i} ( 1 - P )}^{N - i} ( 1 - {( 1 - {C}_{i}^{K} / {C}_{N}^{K} )}^{F} ) , \qquad$$

where C_{N}ⁱPⁱ(1−p)^{N-i} is the probability that exact i bricks fail in one slot, and (1−(1−Cᵢ^{K}/C_{N}^{K})^{F}) is the probability that there is at least on object lost when i bricks fail with i≧K.

With the above Pₛ, MTTDL_{sys} is determined to satisfy the following:

(1−Pₛ)Δ/Pₛ≦MTTDL_{sys}≦Δ/Pₛ.

Thus,

$$\frac{{P}_{s}}{{P}_{o}} ( 1 - {P}_{o} ) \leq \frac{{MTTDL}_{obj}}{{MTTDL}_{sys}} \leq \frac{{P}_{s}}{{P}_{o}} ( 1 - {P}_{s} ) , \\ with {lim}_{P -> 0} ( 1 - {P}_{s} ) = 1 and {lim}_{P -> 0} ( 1 - {P}_{o} ) = 1.$$

$$Therefore , \\ \begin{matrix}π = {lim}_{P -> 0} \frac{{MTTDL}_{obj}}{{MTTDL}_{sys}} = {lim}_{P -> 0} \frac{{P}_{s}}{{P}_{o}} \\ = {lim}_{P -> 0} \frac{{\sum }_{i = K}^{N} {C}_{N}^{i} {{P}^{i} ( 1 - P )}^{N - i} ( 1 - {( 1 - {C}_{i}^{K} / {C}_{N}^{K} )}^{F} )}{{P}^{K}} \\ = {lim}_{P -> 0} {{C}_{N}^{K} ( 1 - P )}^{N - K} ( 1 - {( 1 - {C}_{K}^{K} / {C}_{N}^{K} )}^{F} ) \\ = {C}_{N}^{K} ( 1 - {( 1 - 1 / {C}_{N}^{K} )}^{F} ) \approx {C}_{N}^{K} ( 1 - {e}^{- F / {C}_{N}^{K}} ) .\end{matrix}$$

Some typical values of the above approximation are as follows. When F<<C_{N}^{K}, π≈F; when F>>C_{N}^{K}, π=C_{N}^{K}. In other words, if there are too few objects, then their failures can be regarded as independent; and if there are many objects, then any combination of K bricks can be considered as one independent pattern. Also, when F=C_{N}^{K}, the quantity π is given by π=C_{N}^{K}(1−e⁻¹).

### Exemplary Implementation of the Framework

The above-described analytical framework may be implemented with the help of a computing device, such as a personal computer (PC).

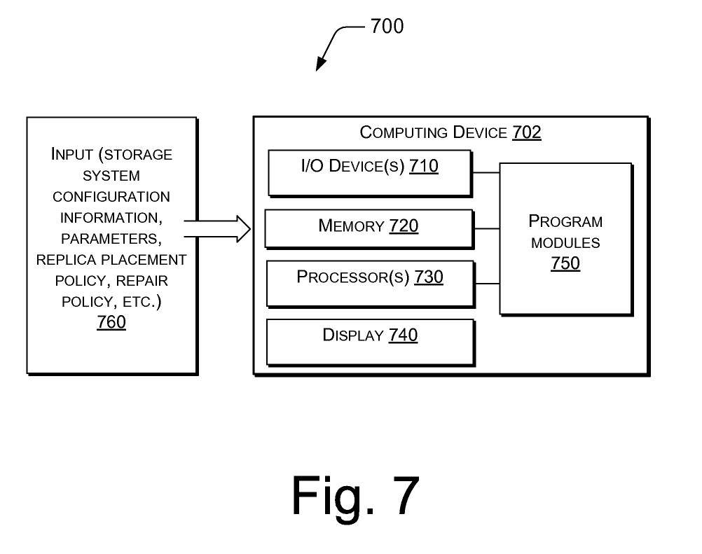

FIG. 7 shows an exemplary environment for implementing the analytical framework to analyze the reliability of the multinode storage system. The system 700 is based on a computing device 702 which includes I/O devices 710, memory 720, processor(s) 730, and display 740. The memory 730 may be any suitable computer-readable media. Program modules 750 are implemented with the computing device 700. Program modules 750 contains instructions which, when executed by a processor, cause the processor to perform actions of a process described herein (e.g., the process of FIG. 2) for estimating the reliability of a multinode storage system under investigation

In operation, input 760 is entered through the computer device 702 to program modules 750. The information entered with input 760 may be, for instance, the basis for actions described in association with blocks 212 and 214 of FIG. 2. The information contained in input 760 may contain a set of parameters describing a configuration of the multinode storage system that is being analyzed. Such information may also include information about network switch topology of the multinode storage system, replica placement strategies, replica repair strategies, etc.

It is noted that the computing device 702 may be separate from the multinode storage system (e.g. the storage system 100 of FIG. 1) that is being studied by the analytical framework implemented in the computing device 702. The input 760 may include information gathered from, or about, the multinode storage system, and be delivered to the computing device 702 either through a computer readable media or through a network. Alternatively, the computing device 702 may be part of a computer system (not shown) that is connected to the multinode storage system and managers the multinode storage system.

It is appreciated that the computer readable media may be any of the suitable memory devices for storing computer data. Such memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-ex-complete instructions may either be delivered in a tangible physical memory device or transmitted electronically.

It is also appreciated that a computing device may be any device that has a processor, an I/O device and a memory (either an internal memory or an external memory), and is not limited to a PC. For example, a computer device may be, without limitation, a set top box, a TV having a computing unit, a display having a computing unit, a printer or a digital camera.

### Parameters of an Exemplary Brick Storage System

The quantitative determination of the parameters discussed above may be assisted by an input of the information of the storage system, such as the information of the network switch topology of the storage system, the replica placement strategy and replica repair strategy. Described below is an application of the present framework used in an exemplary brick storage system using random placement and repair strategy. It is appreciated that the validity and applications of the analytical framework does not depend on any particular choice of default values in the examples.

In a storage system that uses random placement and repair strategy, all replicas of any given object are randomly placed among all bricks in the system. When a replica is lost, a new replica is randomly generated among all remaining bricks in the data repair process.

TABLE 1 shows the system parameters and their default values used in an exemplary analysis.

TABLE 1
Parameters

| Parameter | Explanation | Default |
|---|---|---|
| N | Number of total bricks | 1024 |
| λ = 1/MTTF | Death rate of a brick | ⅓ |
| | | (1/year) |
| K | Replication degree, i.e., | 3 |
| | Desired number of replicas | |
| | per object | |
| D | Total amount of unique | 1 PB |
| | user data | |
| s | Object size | 4 MB |
| B | Switch bandwidth for | 3 GB/s |
| | replica maintenance | |
| b | Brick IO bandwidth | 20 MB/s |
| p | Fraction of B and b | 90% |
| | allocated for repair; (1-p) | |
| | for rebalance | |

The above default values are based on an exemplary peta-byte data storage that could be built in a few years. For example, B=3 GB/s is 10% of the bi-sectional bandwidth of a 10 Gbps 48 port switch, b=20 MB/s is the mixed sequential and random disk access bandwidth, and λ=⅓ yr corresponds to a cheap brick (disk) with 3 year mean time to failure. Although lower failure disk rates are being reported, reported data are based on aggregate failure rates of a number of disks in their initial use (first year), and it is well known that failure rate increases as a disk ages. It is therefore reasonable to choose a higher failure rate to be conservative.

In the exemplary embodiment, most bandwidth of the system (e.g., p=90%) is allocated for data repair, while only a small portion (e.g., p−1=10%) is allocated to rebalance. This is a typical configuration to ensure that the lost replicas are regenerated as fast as possible to support high data reliability.

Table 2 shows formulas for d_{r,i}, b_{r,i}, d₁, and b₁ and their explanations.

TABLE 2
Formulas for the Key Quantities in Random Placement

| | | |
|---|---|---|
| b_{r,i} | min(Bp/A,bp), | Bp/A is the root switch bandwidth |
| | same for all i | allocated for repair for one online |
| | | brick participated in repair; bp is the |
| | | brick IO bandwidth allocated for |
| | | repair. See text for quantity A. |
| d_{r,i} | $\frac{D \times K \times x}{( n + x ) \times A} , \\ same for all i$ | Parameter x is the number of failedbricks whose data still need to berepaired. (D*K)/(n + x) is the amountof data on one brick. With x failedbricks to repair, their data areevenly distributed among the Aremaining bricks as repair source. |
| b₁ | min(b(1 − p) × A/(N − n), | b(1 − p)*A is the total bandwidth |
| | B(1 − p)/(N − n),b) | with which A online bricks can |
| | | contribute for rebalance, and it is |
| | | evenly distributed for (N − n) new |
| | | bricks; B(1 − p) is the root switch |
| | | bandwidth allocated for rebalance, |
| | | and it is also allocated evenly for |
| | | (N − n) new bricks; b is the brick IO |
| | | bandwidth one new brick can use |
| | | for rebalance. |
| dₗ | $\frac{D \times K}{N}$ | Average amount of data one brickshould maintain. |

The quantity A in the formulas and the formula for d_{r,i}, both related to a parameter x, are explained below.

When the system is in a state S=(n, k), part of the data on the N−n failed bricks have been repaired before the system transitions into the state. However, direct information may not be available from the state to derive the exact amount of data still need to be repaired. If extra parameters (coordinates) are added to the state to record this information, the state space may be too large and make the computation infeasible.

In one embodiment designed to overcome this problem, an approximation parameter x is used in the calculation of d_{r,i}. Parameter x denotes the (approximate) number of failed bricks whose data still need to be repaired, and it takes values ranging from 1 to N−n. In other words, when the system is in state S with n online bricks, it is assumed in this exemplary embodiment that in a previous state S′ with n+x online bricks, the system has done, or almost done, its data repair, and only the data in the last x failed bricks need to be repaired in state S.

When x=N−n, the approximation is the most conservative, as it ignores data repaired in all previous states and simply assumes that all data need to be repaired. Without any further information, one can use x=N−n to make a conservative estimate of MTTDL_{sys}. A better estimate of the value of x may be determined by the failure rate of the bricks and the repair speed. Usually, the lower the failure rate and the higher the repair speed, the smaller the value of x.

As discussed in a later section of this description, results of simulation may be used to fine tune the parameter. In the exemplary configuration, it is found that x=1 is sufficiently accurate. This means that the data need to be repaired are mostly the data in the last failed brick and other data are mostly repaired already. This is reasonable at low failure rate (e.g., about 1 failure per day) and relatively high repair speed (e.g., a few tens of minutes to repair one failed brick in parallel).

Quantity A denotes the total number of remaining bricks that can participate in data repair and data rebalance and serve as the data source. Quantity A is calculated as follows.

The total number of objects stored in the system, denoted as F, is given by F=D/s. In state S with n online bricks, the total number of lost replicas is given by FKx/(n+x), assuming that in a previous state S′ with n+x online bricks all data that had been previously lost are repaired. So each brick has FK/(n+x) replicas and, from state S′ to S, all data on the last x failed bricks are lost and need repair. Under such conditions, quantity A is given by minimum of n and FKx/(n+x):

A=min(n,FKx/(n+x)).

This is because, when FKx/(n+x)>n, all lost replicas can be equally distributed among n remaining bricks as data source for repair and rebalance; while when FKx/(n+x)<n, at most FKx/(n+x) bricks can serve as data source for lost replicas.

The calculation of d_{r,i} has similar explanation. Since in state (n, k) the data on the last x failed bricks need repair, and each brick contains DK/(n+x) amount of data, so the total amount of data to repair is DKx/(n+x). These data are eventually distributed among A participating repair sources, so each brick has DKx/[(n+x)A] amount of data to repair.

### Sample Results

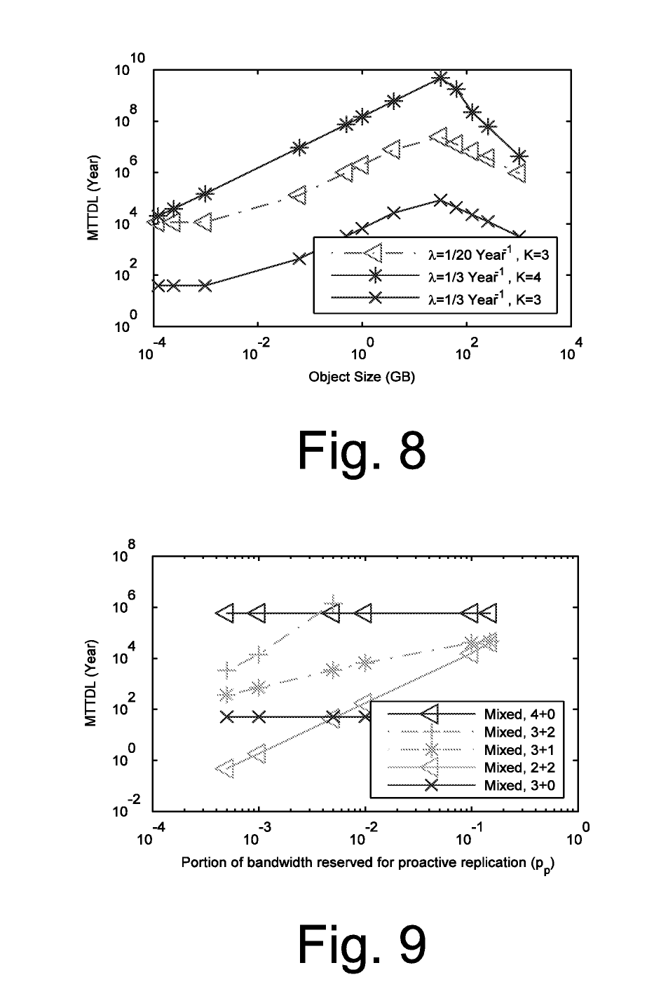

FIG. 8 shows sample results of applying the analytical framework to predict the reliability of the brick storage system with respect to the size of the objects in the system. The result shows that data reliability is low when the object size is small. This is because the huge number of randomly placed objects uses up all replica placement combinations C_{N}^{K}, and any K concurrent brick failures will wipe out some objects.

On the other hand, when the object size is too large, the reliability decreases because there are not enough parallel repair degree to speed up data repair. Therefore, the reliability analysis based on the analytical framework demonstrates that increasing parallel repair bandwidth and decreasing the number of independent objects are two important ways to improve data reliability.

Moreover, there is an optimal object size for system reliability, where the number of independent objects π is reduced to a point at which the system bandwidth is just about fully utilized for parallel repair process.

FIG. 8 also indicates that a 4-way (K=4) replication system with low reliability bricks (e.g., would an average brick life of about three years) can achieve much better reliability than a 3-way (K=3) replication system with high reliability bricks (average brick life time is 20 years). This shows that highly reliable bricks can be traded with lowly reliable (and thus cheaper) bricks with extra disk capacity, and increasing individual brick reliability is less effective than increasing replication degrees of data objects.

In the following, the analytical framework is further applied to analyze a number of issues that are related to data reliability in distributed brick storage systems.

### Topology-aware Placement and Repair

A multinode storage system that is been analyzed may have a switch topology, a replica replacement strategy and a replica repair strategy which are part of the configuration of the multinode storage system. The configuration may affect the available parallel repair bandwidth and the number of independent objects, and is thus an important factor to be considered in reliability analyses. To analyze the reliability of such a multinode storage system, the analytical framework is preferably capable of properly modeling the actual storage system by taking into consideration the topology of the storage system and its replica placement and repair strategies or policies.

The analytical framework described herein may be used to analyze different placement and repair strategies that utilize a particular network switch topology. The analytical framework is able to show that some strategy has better data reliability because it increases repair bandwidth or reduces the number of independent objects.

Referring back to FIG. 1, in an exemplary application of the analytical framework, the storage system being analyzed has a typical switch topology with multiple levels of switches forming a tree topology. The set of bricks attached to the same leaf level switch are referred to as a cluster (e.g., clusters 142, 144 and 146). The traffic within a cluster only traverses through the respective leaf switch (e.g. leaf switch 132, 134 and 136), while traffic between the clusters has to traverse through parent switches such as switches 122, and 124 and the root switch 110. Given the tree topology, the following different replica placement and repair strategies, based on the choices of initial placement (where to put object replicas initially) and repair placement (where to put new object replicas during data repair) are analyzed.

Global placement with global repair (GPGR) strategy—according to GPGR strategy, both initial and repair placement are fully random across the whole system, in which case potential repair bandwidth is bounded by the root switch bandwidth.

Local placement with local repair (LPLR) strategy—according to LPLR strategy, both initial and repair placements are random within each cluster. Essentially each cluster acts as a complete system and data are partitioned among clusters. In this case, potential parallel repair bandwidth is bounded by the aggregate bandwidth of those leaf switches under which there are failed bricks.

All switches have the same bandwidth B as given in TABLE 1. GPGR calculation is already given in TABLE 2. For LPLR, each cluster can be considered as an independent system to compute its MTTDL_{c}, and then the MTTDL_{sys} is MTTDL_{c} divided by the number of clusters.

The analytical framework as described herein is applied to evaluate the reliability of the above two different placement and repair strategies. Comparing GPGR with LPLR, GPGR has much worse reliability when the object size is small, because its placement is not restricted and it has a much larger number of independent objects. When the object size is large, GPGR has better reliability, because in this range there is still enough repair parallelism such that GPGR can fully utilize the root switch bandwidth, while in contrast in LPLR the repair is limited within a cluster of size 48, and thus cannot fully utilize the leaf switch bandwidth for parallel repair.

### Proactive Replication

Another aspect of the replica placement and repair strategies that can be analyzed and evaluated by the analytical framework is proactive replication. A multinode storage system may generate replications in two different manners. The first is the so-called “reactive repair” which performs replications in reaction to a loss of a replication. Most multinode storage systems have at least this type of replication. The second is “proactive replication” which is done proactively without waiting for a loss of a replication to happen. Reactive repair and proactive replication may be designed to beneficially share available resources such as network bandwidth.

Network bandwidth is a volatile resource, meaning that free bandwidth cannot be saved for later use. Many storage applications are IO bound rather than capacity bound, leaving abundant free storage space. Proactive replication exploits such two types of free resources to improve reliability by continuously generating additional replicas besides the desired number K in the constraint of fixed allocated bandwidth. When using proactive replication together with reactive data repair strategy (i.e., a mixed repair strategy), the actual repair bandwidth consumed when failures occur is smoothed by proactive replication and thus big bursts of repair traffic can be avoided. When configured properly, the mixed strategy may achieve better reliability with a smaller bandwidth budget and extra disk space.

The analytical framework is used to study the impact of proactive replication to data reliability in the setting of GPGR strategy. As previously described, the study chooses an observed object to focus on. The selected observed object is referred to as “the object” or “this object” herein unless otherwise specified. When the number of replicas of this object drops below the desired degree K, the system tries to repair the number of replicas to K using reactive repair. The system also uses reactive rebalance to fill new empty bricks. Once the number of replicas reaches K, the system switches to proactive replication to generate additional replicas for this object.

To study proactive replication, the model described in FIGS. 4-5 is extended by adding states (N, K+1), (N−1, K+1), . . . , (N, K+2), (N−1, K+2), . . . , until (N, K+Kₚ), (N−1, K+Kₚ), where Kₚ is the maximal number of replicas generated by proactive replication. The calculation of transition rates with this extended state space are described as follows.

First, for every state (n, k), the two failure transitions λ₁ and λ₂ leaving state (n, k) have the same formulas λ₁=(n−k)λ and λ₂=kλ as before, because state (n, k) by definition has n online bricks and k of them have replicas of the object.

Second, a slightly different consideration is given to the repair and rebalance transitions μ₁, μ₂ and μ₃ as compared to that in FIG. 5. Because reactive repair, rebalance, and proactive replication all evenly reproduce data among bricks, one could logically divide data on a brick into two categories for the purpose of analysis, the first category being data maintained by reactive repair and rebalance, called reactive replicas, and the second category being those generated by proactive replication, called proactive replicas. Such a classification simplifies the analysis without distorting the working of the modeled system.

For the state (n, k) with k<K, there is one transition to (n, k+1) for reactive repair, and two transitions to (n+1,k+1) and (n+1,k) for rebalance. Since by the above classification reactive repair and rebalance do not need to regenerate proactive replicas, the computation of these transition rates is exactly like that described previously in relation to FIG. 3, except that now there is a new bandwidth allocation. The switch bandwidth and brick bandwidth are divided into three components: pᵣ for reactive repair, p₁ for rebalance, and pₚ for proactive replication, where pᵣ+p₁+pₚ=1. That is, the proactive replication bandwidth is restricted to be pₚ percent of total bandwidth, usually a small percentage (e.g., 1%). With this allocation, one only needs to modify the calculations in TABLE 2 such that p is replaced with pᵣ and (1−p) is replaced with p₁. The rest calculation of μ₁ μ₂ and μ₃ remains the same for state (n, k) with k<K.

For proactive replication and rebalance transitions from state (n, k) with k≧K, μ₁, μ₂ and μ₃ are different from that in FIG. 5. First, here μ₂=0, as rebalance does not generate proactive replicas for this object. Thus transition from (n, k) to (n+1, k) is the only transition for rebalance, and μ₃=(N−n)×b₁/d₁, where b₁ and d₁ are the same as in TABLE 2 with p₁ replacing (1−p).

For the proactive replication transition from (n, k) to (n, k+1) when k≧K, g, is also different from that in FIG. 5. To calculate μ₁, the method here calculates quantities dₚ and bₚ, where dₚ is the amount of data for proactive replication in state (n, k), and bₚ is the bandwidth allocated for proactive replication, all for one online brick. However, state (n, k) does not provide enough information to derive dₚ directly. To avoid introducing another parameter into the state and causing state space explosion, the method here estimates dₚ by calculating the mean number of online bricks denoted as L. In the exemplary model, parameter L is calculated using only reactive repair (with pᵣ bandwidth) and rebalance (with p₁ bandwidth).

The total number of online bricks that can participate in proactive replication is denoted as Aₚ, which is expressed as Aₚ=min(n, FKp(N−L)/N). Then dₚ=DKp(N−L)/(NAₚ), because (DKₚ)/N is the amount of data on one brick that are generated by proactive replication, there are (N−L) bricks that lose data by proactive replication, and all these data can be regenerated in parallel by Aₚ online bricks. The calculation of Aₚ and dₚ does not include a parameter x used in A and d_{r,i}. This is because proactive replication uses much smaller bandwidth than data repair and one cannot assume that most of the lost proactive replicas have been regenerated. For bₚ, one has bₚ=min(Bpₚ/Aₚ, bpₚ) similar to the counterpart with k<K.

The transition rate μ₁ is thus given by μ₁=(Kₚ+K−k)bₚ/dₚ, because there are (Kₚ+K−k) proactive replicas for the object to be regenerated, and each has the rate bₚ/dₚ.

FIG. 9 shows sample results of applying the analytical framework to compare the reliability achieved by reactive repair and the reliability achieved by mixed repair with varied bandwidth budget allocated for proactive replication. It also shows different combinations of reactive replica number K and proactive replica number Kₚ. In FIG. 9, a repair strategy using K (for reactive repair) and Kₚ for proactive repair is denoted as “K+Kₚ”. For example, “3+1” denotes a mixed repair strategy having K=3 and Kₚ=1. In FIG. 9, object size is 4M. Bandwidth budget for rebalance p₁=10%. The results of the comparison are discussed as follows.

First, with increasing bandwidth budget allocated for proactive replication, the reliability of mixed repair significantly improves, although still lower than pure reactive repair with same number of replicas. For example, when proactive replication bandwidth increases from 0.05% to 10%, the reliability of mixed repair with “3+1” combination improves two orders of magnitude, but is still lower than that of reactive repair with 4 replicas (by an order of magnitude). Mixed repair with “2+2” also shows similar trends.

Second, mixed repair provides the potential to dramatically improve reliability using extra disk space without spending more bandwidth budget. Comparing the mixed repair strategies “3+2” with “3+1”, one sees that “3+2” has much better reliability under the same bandwidth budget for proactive replication. That is, without increasing bandwidth budget, “3+2” provides much better reliability by use some extra disk capacity. Comparing “3+2” with reactive repair “4+0”, when the bandwidth budget for proactive replication is above 0.5%, “3+2” provides the same level of reliability as “4+0” (larger bandwidth budget results are not shown because the matrix I−Q* is close to singular and its inversion cannot be obtained). Therefore, by using extra disk space, it is possible to dramatically improve data reliability without incurring much burden on system bandwidth.

### The Delay of Failure Detection

The previously described exemplary model shown in FIGS. 4-5 assumes that the system detects brick failure and starts the repair and rebalance instantaneously. That model is referred to as Model 0. In reality, a system usually takes some time, referred to as failure detection delay, to detect brick failures. In this regard, the analytical framework may be extended to consider failure detection delay and study its impact on MTTDL. This model is referred to as Model 1.

In real systems, failure detection techniques range from simple multi-round heart-beat detection to sophisticated failure detectors. Distributions of detection delay vary in these systems. For simplicity, the following modeling and analysis assume that the detection delay obeys exponential distribution.

One way to extend from Model 0 to Model 1 to cover detection delay is to simply expand the two-dimensional state space (n, k) into a three-dimensional state space (n, k, d), where d denotes the number of failed bricks that have been detected and therefore ranges from 0 to (N−n). This method, however, is difficult to implement because the state space is exploded to O(KN²). To control the size of the state space, an approximation as discussed below is taken.

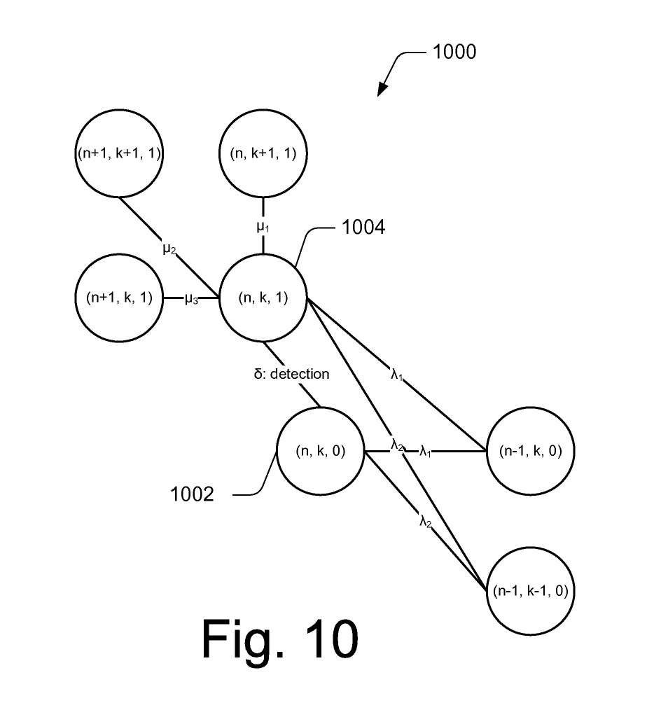

FIG. 10 shows an exemplary transition pattern of an extended model that covers detection delay. The transition pattern 1000 takes a simple approximation by allowing only 0 and 1 for value d. In this approximation, d=0 means that the system has not detected any failures and will do nothing, and d=1 means that the system has detected all failures and will start the repair and rebalance process. As long as the detection delay is far less than the interval of two consecutive brick failures (an assumption holds for most of real systems), the approximation is reasonable. The transitions and rates of FIG. 10 are calculated as follows.

Assume the system is at state (n, k, 0) 1002 initially. After a failure occurs, the system may be in either state (n, k, 0) 1002 or state (n, k, 1) 1004, depending on whether the failure has been detected. There is a delay of 1/δ for detection between state (n, k, 0) 1002 or state (n, k, 1) 1004. State (n, k, 1) 1002 or (n, k, 1) 1004 transits to state (n−1, k, 0) at rate λ₁ if no replica is lost, or to state (n−1, k−1, 0) at rate λ₂ if one replica is lost. To be conservative a state is always transited to an undetected state (d=0) after a failure. The calculation of rates λ₁ and λ₂ are the same as in Model 0 of FIGS. 4-5.

The transition from state (n, k, 0) to state (n, k, 1) represents failure detection, the rate of which is denoted δ (1/δ is the mean detection delay). In state (n, k, 0) 1002 there is no transition for data repair and rebalance because failure detection has not occurred yet. State (n, k, 1) 1004 could transit to state (n, k+1, 1), (n+1, k+1, 1), or (n+1, k, 1) with respective transition rates μ₁, μ₂, and μ₃, representing data repair and rebalance transitions. The calculations of μ₁, μ₂, and μ₃ are the same as in Model 0.

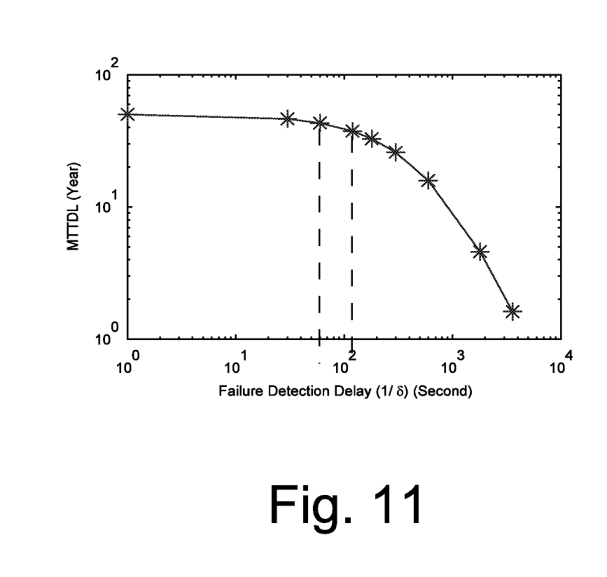

FIG. 11 shows sample reliability results of the extended model of FIG. 10 covering failure detection delay. A diagram of FIG. 11 shows MTTDL_{sys} with respect to various mean detection delays. The result demonstrates that a failure detection delay of 60 seconds has only small impact on MTTDL_{sys} (14% reduction), while a delay of 120 seconds has moderate impact (33% reduction). Such quantitative results can provide guideline on the speed of failure detection and helps the design of failure detectors.

### The Delay to Replace Failed Brick

The analytical framework may be further extended to cover the delay of replacing failed bricks. This model is referred to as Model 2. In the previous Model 0 and Model 1, it is assumed that there are enough empty backup bricks so that failed bricks would be replaced by these backup bricks immediately. In real operation environments, failed bricks are periodically replaced with new empty bricks. To save operational cost, the replacement period may be as long as several days. In this section, the analytical framework is used to quantify the impact of replacement delay to system reliability.

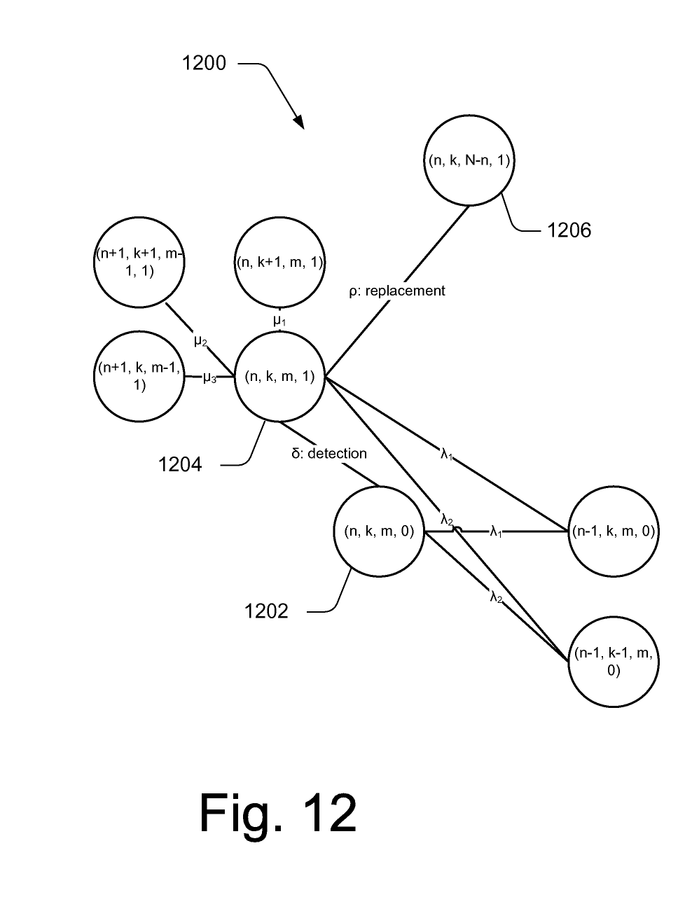

FIG. 12 shows an exemplary transition pattern of an extended model that covers failure replacement delay. To model brick replacement, the state (n, k, d) in Model 1 of FIG. 10 is further split into states (n, k, m, d), where m denotes the number of existing backup bricks and ranges from 0 to (N−n). Number m does not change for failure transitions. Compared to the transition pattern 1000 of FIG. 10, the transition pattern 1200 here includes a new transition from state (n, k, m, 1) 1204 to state (n, k, N−n, 1) 1206. The new transition represents a replacement action that adds (N−n−m) backup bricks into the system. The rate for this replacement transition is denoted as ρ (for simplicity assuming replacement delay follows an exponential distribution). When m>0 and d=1, rebalance transitions μ₂ and μ₃ may occur from state (n, k, m, 1) 1204 to state (n+1, k, m−1, 1) or (n+1, k+1, m−1, 1), and as a result the number of online bricks is increased from n to n+1 while the number of backup bricks is decreased from m to m−1.

The computations of failure transition rates λ₁ and λ₂ are the same as in the transition pattern 1000 of FIG. 10. For rebalance transitions μ₂ and μ₃, one only needs to replace (N−n) in the formula for b₁ with m, and replace N in the formula for d₁ with (n+m), since only (n+m) bricks can participate in rebalance and only m new bricks can receive data for rebalance. The calculation of repair transition rate μ₁ is the same as in the transition pattern 500 of FIG. 5 (Model 0) and the transition pattern 1000 of FIG. 10 (Model 1).

In Model 2, the state space explodes to O(KN²) with m ranging from 0 to (N−n). This significantly reduces the scale at which one can compute MTTDL_{sys}. In some embodiments, the following approximations are taken to reduce the state space.

First, instead of m taking entire range from 0 to (N−n), the exemplary approximation restricts m to take either 0 or values from (N−n−M) to (N−n), where M is a predetermined constant. With this restriction, the state space is reduced to O(KNM). The restriction causes the following change in failure transitions: State (n, k, m, d) transits to state (n−1, k, m, 0) or state (n−1, k−1, m, 0) if m is at least (N−(n−1)−M), otherwise it transits directly to state (n−1, k, 0, 0) or state (n−1, k−1, 0, 0) because m would be out of the restricted range if m were kept unchanged. In the following exemplary calculation, M is set to be 1.

Second, the exemplary approximation sets a value cutoff, such that one can collapse all states with n<cutoff to the stop state. This is a conservative approximation that underestimates MTTDL_{sys}.

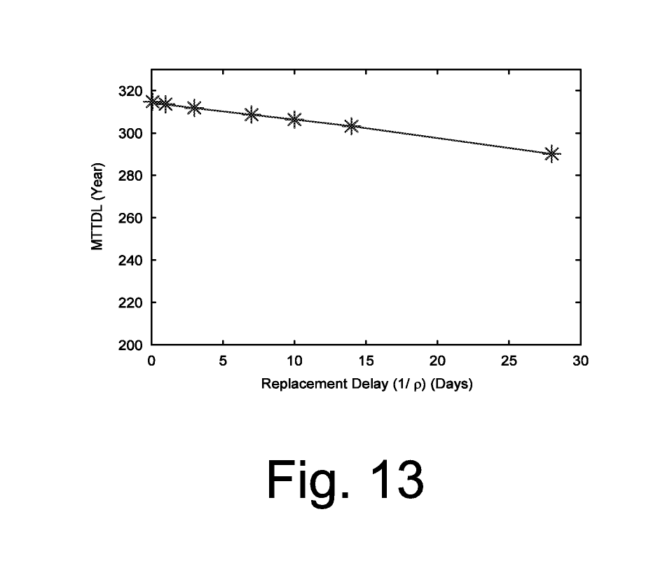

FIG. 13 shows sample computation results of impact on MTTDL by replacement delay. The brick storage system studied has 512 bricks. The cutoff is adjusted to 312 at which point further decreasing cutoff does not show very strong improvement to MTTDL_{sys}. The results show that replacement delay from 1 day to 4 weeks does not lower the reliability significantly (only 8% drop in reliability with 4 weeks of replacement delay). This is can be explained by noting that replacement delay only slows down data rebalance but not data repair, and data repair is much more important to data reliability.

The results suggest that, in environments similar to the settings modeled herein, brick replacement frequency has a relatively minor impact on data reliability. In such circumstances, system administrators may choose a fairly long replacement delay to reduce maintenance cost, or determine the delay frequency based on other more important factors such as performance.

Verification and Tuning with Simulation

The results of the analytical framework described herein are verified with event-driven simulations. The simulation results may also be used to refine parameter x (the number of failed bricks that account for repair data). The event-driven simulation is down to the details of each individual objects. The simulation includes more realistic situations that have been simplified in the analysis using the analytical framework, and is able to verify the analysis in a short period of time without setting up an extra system and running it for years.

In the simulation runs, objects are initially distributed uniformly at random across bricks, which are all connected to a switch. Brick life time, data transfer time, detection delay, and replacement delay all follow exponential distributions. Once a brick fails, a scheduler randomly selects source-destination pairs for both data repair and rebalance. All source-destination pairs enter a waiting queue to be processed. The network bandwidth B is divided into a number of evenly distributed processing slots, each of which takes one source-destination pair from the waiting queue to process at a time, and thus the maximum bandwidth one slot can use is the brick bandwidth b. The number of slots is configured such that the total bandwidth used by all slots is the switch bandwidth B. The simulation is stopped once some object loses all its replicas.

In order to be able to simulate the behavior of each individual object in the system, the scale of the simulation is limited. In contrast, the analytical framework described herein is able to analyze storage systems of much larger scales.

The simulation results (not shown) match very well with the trend (as object size increases) predicted by the analytical framework using the basic Model 0. Since the simulation is at the individual object level, it naturally accounts for partial repair and rebalance, which means that the data repair and rebalance effort spent in one state will not be lost when the system transitions to another state. This provides an opportunity to tune parameter x, which denotes the approximate number of failed bricks whose data still need to be repaired when the system has lost N−n bricks.

The parameter x generally increases when the failure rate is higher and repair rate is lower. The conservative approximation of x=N−n does lower the reliability prediction (sometimes to an order of magnitude), but when x=1, the theoretical prediction aligns with the simulation results quite well (with most data points falling into the 95% confidence interval). Since the failure rate in the simulation setting (0.1 year brick life time with 150 bricks) is higher than the analytical setting (3 year brick life time with 1024 bricks), while the repair bandwidth in the simulation is much lower than that used in the analytical framework (125 MB/s vs. 3 GB/s), the result suggests that using x=1 in the analytical framework under the sample settings is reasonable.

The simulation results have also been compared with results of the analytical framework using Model 1 which considers failure detection delay. The results again show that using x=N−n one can obtain a conservative prediction while using x=1 one can obtain a theoretical prediction that is both close in trend and in values to the simulation results.

Overall, the simulation results both verify that the analytical framework provides correct predictions in the reliability trends. When certain system parameters are adjusted and tuned, it is possible to obtain fairly accurate reliability prediction from the analytical framework.

### CONCLUSION

The analytical framework is described for analyzing the reliability of a multinode storage system (e.g., a brick storage) in the dynamics of node (brick) failures, data repair, data rebalance, and proactive replication. The framework can be applied to a number of brick storage system configurations and provide quantitative results to show how data reliability can be affected by the system configuration including switch topology, proactive replication, failure detection delay, and brick replacement delay. The framework is highly scalable and capable of analyzing systems that are too large and too expensive for experimentation and even simulation. The framework has a potential to provide important guidelines to storage system designers and administrators on how to fully utilize system resources (extra disk capacity, available bandwidth, switch topology, etc) to improve data reliability while reducing system and maintenance cost.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for estimating reliability of a multinode storage system, the method comprising:
defining a state space of the multinode storage system, the state space comprising a plurality of states, each state being described by at least a first coordinate and a second coordinate, the first coordinate being a quantitative indication of online status of the multinode storage system, and the second coordinate being a quantitative indication of replica availability of an observed object stored in the multinode storage system; and
determining, using a stochastic process, a metric measuring a transition time from a start state to an end state for estimating the reliability of the multinode storage system.

2. The method as recited in claim 1, wherein the first coordinate comprises n denoting a current number of online nodes in the multinode storage system, and the second coordinate comprises k denoting a current number of replicas of the observed object, each state being at least partially described by (n, k).

3. The method as recited in claim 2, wherein the start state is described by (N, K), N denoting total number of nodes in the multinode storage system, and K denoting desired replication degree of the observed object.

4. The method as recited in claim 2, wherein the end state is an absorbing state in which all replicas of the observed object are lost, the absorbing state being described by (n, 0).

5. The method as recited in claim 2, wherein n has a range of K≦n≦N, and k has a range of 0≦k≦K, where N denotes total number of nodes in the multinode storage system, and K denotes desired replication degree of the observed object.

6. The method as recited in claim 2, wherein n has a range of K≦n≦N, and k has a range of 0≦k≦K+Kₚ, where N denotes total number of nodes in the multinode storage system, K denotes desired replication degree of the observed object, and Kₚ denotes maximum number of additional replicas of the observed object generated by proactive replication.

7. The method as recited in claim 2, further comprising:
defining a state space transition pattern between the plurality of states in the state space; and
determining transition rates of the state space transition pattern, the determined transition rates being used for determining the metric measuring the transition time from the start state to the end state,
wherein the state space transition pattern including:
a first transition from state (n, k) to state (n−1, k) in which a node fails but no loss of a replica of the observed object occurs;
a second transition from state (n, k) to state (n−1, k−1) in which the node fails and a replica of the observed object is lost;
a third transition from state (n, k) to state (n, k+1) in which a repair replica of the observed object is generated among remaining n nodes;
a fourth transition from state (n, k) to state (n+1, k+1) in which a new node is added for data rebalancing and a repair replica of the observed object is generated in the new node; and
a fifth transition from state (n, k) to state (n+1, k) in which a new node is added for data rebalancing without generating a repair replica of the observed object.

8. The method as recited in claim 1, wherein the stochastic process is a Markov process.

9. The method as recited in claim 1, wherein the metric is mean time to data loss of the multinode storage system denoted by MTTDL_{sys}.

10. The method as recited in claim 1, wherein determining the metric comprises:
determining mean time to data loss of the observed object denoted by MTTDL_{obj};
determining π which denotes number of independent objects stored in the multinode storage system; and
approximating mean time to data loss of the multinode storage system (MTTDL_{sys}) based on MTTDL_{sys}=(MTTDL_{obj})/π.

11. The method as recited in claim 10, wherein determining π comprises:
configuring an ideal model of the multinode storage system in which time is divided into discrete time slots, each time slot having a length Δ, wherein in each time slot each node has an independent probability to fail, and at the end of each time slot, data repair and data rebalance are completed instantaneously;
determining MTTDL_{obj, ideal} and MTTDL_{sys, ideal}, which denote mean time to data loss of the observed object in the ideal model and mean time to data loss of the multinode storage system in the ideal model, respectively; and
approximating π based on ratio MTTDL_{obj, ideal}/MTTDL_{sys, ideal} by letting the time slot length Δ tend to zero.

12. The method as recited in claim 1, further comprising:
defining a state space transition pattern between the plurality of states in the state space; and
determining transition rates of the state space transition pattern, the determined transition rates being used for determining the metric measuring the transition time from the start state to the end state.

13. The method as recited in claim 12, wherein determining transition rates of the state space transition pattern comprises:
providing at least some of a set of parameters including number of total nodes (N), failure rate of a node (λ), desired number of replicas per object (replication degree K), total amount of unique user data (D), object size (s), switch bandwidth for replica maintenance (B), node I/O bandwidth, fraction of B and b allocated for repair, fraction of B and b allocated for rebalance, failure detection delay, and failure replacement delay; and
determining the transition rates based on the provided parameters.

14. The method as recited in claim 1, further comprising:
providing a network switch topology of the multinode storage system;
providing a replica placement strategy;
providing a replica repair strategy;
providing at least some of a set of parameters including number of total nodes (N), failure rate of a node (λ), desired number of replicas per object (replication degree K), total amount of unique user data (D), object size (s), switch bandwidth for replica maintenance (B), node I/O bandwidth, fraction of B and b allocated for repair, and fraction of B and b allocated for rebalance;
defining a state space transition pattern between the plurality of states in the state space; and
determining transition rates of the state space transition pattern.

15. The method as recited in claim 1, wherein each node of the multinode storage system comprises a brick storage unit.

16. A method for optimizing a multinode storage system for optimal reliability, the method comprising:
defining a state space of the multinode storage system, the state space comprising a plurality of states, each state being described by at least a first coordinate and a second coordinate, the first coordinate being a quantitative indication of online status of the multinode storage system, and the second coordinate being a quantitative indication of replica availability of an observed object stored in the multinode storage system;
providing a plurality of test configurations of the multinode storage system, each configuration being defined by at least some of a set of parameters including number of total nodes (N), failure rate of a node (λ), desired number of replicas per object (replication degree K), total amount of unique user data (D), object size (s), switch bandwidth for replica maintenance (B), node I/O bandwidth, fraction of B and b allocated for repair, fraction of B and b allocated for rebalance, failure detection delay and brick replacement delay; and
for each test configuration, determining using a stochastic process a metric measuring a transition time from a start state to an end state for estimating the reliability of the test configuration.

17. The method as recited in claim 16, further comprising:
defining a state space transition pattern between the plurality of states in the state space; and
for each test configuration, determining transition rates of the state space transition pattern.

18. The method as recited in claim 16, further comprising:
providing a network switch topology of the multinode storage system;
providing a replica placement strategy;
providing a replica repair strategy;
defining a state space transition pattern between the plurality of states in the state space; and
determining transition rates of the state space transition pattern based on the network switch topology, the replica placement strategy, the replica repair strategy, and the set of parameters, wherein the transition rates are used for determining the metric for estimating the reliability of test configuration of the multinode storage system.

19. The method as recited in claim 16, wherein the stochastic process is a Markov process and the metric is mean time to data loss of the multinode storage system denoted by MTTDL_{sys}.

20. One or more computer readable media having stored thereupon a plurality of instructions that, when executed by a processor, causes the processor to:
defining a state space of the multinode storage system, the state space comprising a plurality of states, each state being described by at least a first coordinate and a second coordinate, the first coordinate being a quantitative indication of online status of the multinode storage system, and the second coordinate being a quantitative indication of replica availability of an observed object stored in the multinode storage system; and
determining, using a stochastic process, a metric measuring a transition time from a start state to an end state for estimating the reliability of the multinode storage system.
